(19) United States
(12) Patent Application Publication
(10) Pub. No.: US 2007/0067480 A1
(43) Pub. Date: Mar. 22, 2007

(54) Adaptive media playout by server media processing for robust streaming

(75) Inventors: Petrus J. L. van Beek, Camas, WA (US); Louis Joseph Kerofsky, Camas, WA (US)

Correspondence Address: KEVIN L. RUSSELL;CHERNOFF, VILHAUER, MCCLUNG & STENZEL LLP, 1600 ODSTOWER, 601 SW SECOND AVENUE, PORTLAND, OR, 97204, US

(73) Assignee: Sharp Laboratories of America, Inc.

(21) Appl. No.: 11/417,693

(22) Filed: May 4, 2006

Related U.S. Application Data
(60) Provisional application No. 60/718,625, filed on Sep. 19, 2005.

(51) Int. Cl. G06F 15/16

(52) U.S. Cl. 709/231

(57) ABSTRACT

A system for sending video includes a sender creating a second plurality of frames for a temporal time period of the video based upon a first plurality of frames for the temporal time period of the video. The creating is such that the second plurality of frames includes a greater number of frames than the first plurality of frames. The sender seconds the second plurality of frames to a receiver at a frame rate greater than the frame rate at which the receiver is going to render the second plurality of frames.

### CROSS-REFERENCE TO RELATED APPLICATIONS

This application claims the benefit of U.S. Prov. App. No. 60/718,625, filed Sep. 19, 2005.

### BACKGROUND OF THE INVENTION

High-quality and robust transmission of audio/video (AV) streams from a source device, for example a home server, to one or more receiving devices, for example TV sets in a home, over a network, for example over a local area network (LAN) is desirable. Such a network may include interconnections based on wired (for example Ethernet), wireless (for example IEEE 802.11 wireless), or power-line (for example HomePlug) links. The application may require transmission of stored audio and video streams (streaming). The application may also require transmission of live audio and video, and may require some level of interaction, such as channel changing. Therefore, maximum end-to-end delay is normally limited to up to one second or a few seconds.

The available bandwidth of wireless networks (such as those based on IEEE 802.11) and other types of home networks may be limited, may vary over time and may be unpredictable due to various reasons. Transmission of compressed AV streams over such networks is difficult because high-quality AV streams require a relatively high bandwidth continuously, and due to the stringent delay constraints on delivery of AV data. Degradations of network conditions may result in losses and delays of packets carrying AV data. Delayed packets arriving at the receiver after their delivery deadline has passed may also be considered lost. AV data that is lost or arrives late at the receiver may lead to unacceptable distortions in the rendered output or interruptions of the rendering.

Systems for audio/video transmission over packet networks (such as streaming media systems) may utilize (a) buffer(s) at the receiver, such as a transmission buffer and/or a decoder buffer. Packets with AV data that are received from the network are stored temporarily in these buffers before being fed into the AV decoder. These buffers absorb variations in the delay with which packets with AV data are transported across the network (delay jitter). Buffering reduces the probability of decoder buffer underflow—events where AV data arrives late at the receiver due to variations in transmission delay. Such events result in distortions or interruptions of the rendering of the AV stream at the receiver. Hence buffering increases playout robustness.

Reducing the playout delay that is common in systems for streaming compressed audio/video data over packet networks, due to receiver-side data buffering is desirable. Playout delay is also referred to as startup delay or startup latency. It is experienced by users of streaming media systems as a delay in the response to a request for playing an AV media stream, for example when starting a new stream or when switching between streams. For example, in media streaming over the Internet, a user who requested to play audio/video content may have to wait a number of seconds (such as 5 or 10 seconds) before the content is rendered, while the receiver is buffering AV data. However, users of TV receivers are accustomed to an immediate response to requests such as changing a channel. Therefore, a solution to this is needed in particular for systems that stream high-quality audio/video media over home networks to high-quality displays that also function as broadcast TV receivers.

The conventional method to increase playout robustness is to increase playout delay, for example by increasing the amount of data that is buffered at the decoder. However, this comes at the cost of decreased user satisfaction due to the increased delay in the system response to user requests. It is desirable to enable increasing playout robustness without increasing playout delay; or reducing playout delay without reducing playout robustness; or reducing playout delay and increasing playout robustness.

Basic Adaptive Media Playout (AMP) is realized by processing the media at the receiver, which has the disadvantage of increased cost of the receiver. Moreover, existing receivers do not have the capability to implement AMP.

One disadvantage of AMC is that it applies only to a scenario where the audio/video data is pre-encoded and stored on the server before the start of its transmission; hence, it does not apply to a scenario with live audio/video input.

### BRIEF DESCRIPTION OF THE DRAWINGS

FIG. 1 illustrates reducing playout rate.

FIG. 2 illustrates adaptive media playout.

FIG. 3A illustrates an audio/video transmission system.

FIG. 3B illustrates an audio/video transmission system.

FIG. 4A illustrates AMP-SMP with pixel domain frame rate conversion.

FIG. 4B illustrates frame rate conversion.

FIG. 5A illustrates AMP-SMP with compressed domain frame rate conversion.

FIG. 5B illustrates frame rate conversion.

### DETAILED DESCRIPTION OF THE INVENTION

The system can be understood as a technique to achieve Adaptive Media Playout (AMP). In AMP, the media playout rate is adapted to the fullness of the receiver (client) buffer. In particular, the playout rate may be reduced relative to the normal rate (e.g. video frame rate) temporarily at the beginning of a streaming session, which enables the receiver to reduce startup latency by starting to render media while the receiver buffer continues to fill up. Conventionally, playout of video at a reduced rate is realized by the receiver (client) in one of the following ways: (a) by increasing the duration that each video frame is displayed, hence reducing the display frame rate; (b) by increasing the number of fields/frames to be displayed while keeping the display frame rate at the normal frame rate. The latter involves video frame rate conversion, for example by field or frame repetition, or by frame interpolation, possibly motion-compensated frame interpolation. The audio data is processed separately, and may be time scaled, preferably without altering the pitch. AMP may also be referred to as time scale modification.

Realizing AMP at the receiver (client) has the disadvantage that special processing of audio and video is needed, which may increase the cost of the receiver. Typical broadcast TV receivers do not have the capability to realize AMP at the receiver and hence can not take advantage of the improvement in playout robustness offered by AMP.

It is preferred to perform frame rate conversion at the sender (server) side, instead of at the receiver (client), in order to achieve adaptive playout. Furthermore, the converted video stream with increased frame rate is transmitted at the increased frame rate, i.e., an increased number of video frames per second are transmitted compared to the number of video frames in the original input video stream. Since an increased number of video frames per second are transmitted, video bit rate adaptation may be utilized to control the video transmission bit rate appropriately considering the channel conditions. In particular, the video bit rate may be reduced in case of a bandwidth-limited channel, in part to compensate for the increased number of video frames to be transmitted per second. Finally, at the receiver (client), the video is played out at the normal frame rate, i.e., the frame rate of the original input video stream. Because the receiver (client) buffer receives frames from the channel (network) at a higher rate than are retrieved from the buffer, the fullness of the buffer will grow over time. The resulting effects in terms of time scale modifications are the same as those in conventional AMP. To achieve time scaling at the receiver (client), the sender (server) may modify the appropriate presentation time stamps in the AV stream. Furthermore, time scale modification of the audio stream is also realized at the sender (server). The potential increase in transmission bit rate needed for the modified audio stream is expected to be small, so that it does not need further consideration (although audio bit rate adaptation may also be applied if necessary). This may be referred to as Adaptive Media Playout by Server Media Processing (AMP-SMP).

The primary advantage of the resulting AMP-SMP system compared to the conventional client-side implementation of AMP is that the special processing and associated complexity to achieve AMP is taken out of the client. In the AMP-SMP system, the client is essentially the same as a client in a traditional system with no AMP at all. Hence, the beneficial effects of AMP can be achieved without increasing the cost of the receiver (client). AMP-SMP provides the benefits of robust playout for clients based on broadcast receivers without modifying the basic audio/video processing within the receiver. Another advantage of the AMP-SMP system is that it can be applied to a live audio/video coding scenario, in addition to streaming of pre-encoded audio/video. This is also the case for basic AMP.

Furthermore, an advantage of the AMP-SMP system with bit rate adaptation compared to an AMP system with bit rate adaptation (due to bandwidth limitations) is that the frame rate conversion at the sender (server) can be applied on the original input video, i.e. before encoding or before bit rate reduction is applied by a transcoder. Compared to application of client-side frame rate conversion in a system where an encoder or transcoder lowers the bit rate of the input video, application of server-side frame rate conversion may result in a higher quality conversion result.

The bit rate of the converted AV stream (with increased frame rate) can be adapted at the sender (server) and may depend on the available channel (network) bandwidth, as well as other system and channel conditions. Limitations and variations of the channel conditions can be taken into account. The use of real-time transcoding, and adaptation of the bit rate of the AV stream to optimize the AV quality, in combination with frame rate conversion to achieve adaptive media playout.

Moreover, the bit rate of the AV stream can be controlled using a method of delay-constrained rate adaptation. Utilizing this method involves determining a constraint on the end-to-end delay, and adapting the bit rate of the AV stream such that video frames substantially arrive on time, even in the case where the number of video frames being transcoded and transmitted per second has been increased, and playout delay has been reduced. Delay-constrained rate adaptation may take into account the expected delays of video frames during transmission, or may take into account the expected available bandwidth for transmission of AV data. Therefore, limitations and variations of the channel bandwidth can be taken into account. Delay-constrained rate adaptation may also take into account the system status, such as fullness of the various buffers in the system, for example an encoder buffer, a decoder buffer, and other buffers. The use of delay-constrained rate adaptation in combination with frame rate conversion to achieve adaptive media playout is another unique aspect of this invention.

Another aspect is that the system may be designed such that the frame rate conversion process and subsequent encoding or transcoding process at the sender/server are aware of each other, and can be jointly optimized for visual quality. Alternatively, the frame rate conversion and encoding/transcoding can be realized jointly by a single process, i.e., frame rate conversion is realized by the encoder or transcoder, to improve the visual quality.

Another aspect is that when a client is capable of AMP, the media playout can be adapted by both the server and/or the client. The server is able to jointly optimize the division of the AMP processing between itself and the client optimally selecting the number of video frames to transmit and the number of frames to interpolate at the client.

While reducing the playout rate in order to be able to the reduce the startup latency is an important feature, AMP also includes increasing the playout rate in order to reduce the end-to-end delay or latency during transmission. This is useful in the case of live audio/video input, since it may be undesirable to let the latency increase without limit, as such latency may become noticeable when displaying live events. With AMP-SMP, an increase of the playout rate at the receiver can be realized by reducing the frame rate at the sender. In this case, frame rate conversion means frame rate reduction, for example, by dropping frames or fields from the video stream. This implies that in this case a reduced number of frames have to be transmitted from sender to receiver. This may mean that during such time intervals, the bit stream may be encoded at a higher quality by the sender. Therefore, another advantage of AMP-SMP compared to basic AMP is that, during some time intervals, higher quality video can be received and displayed.

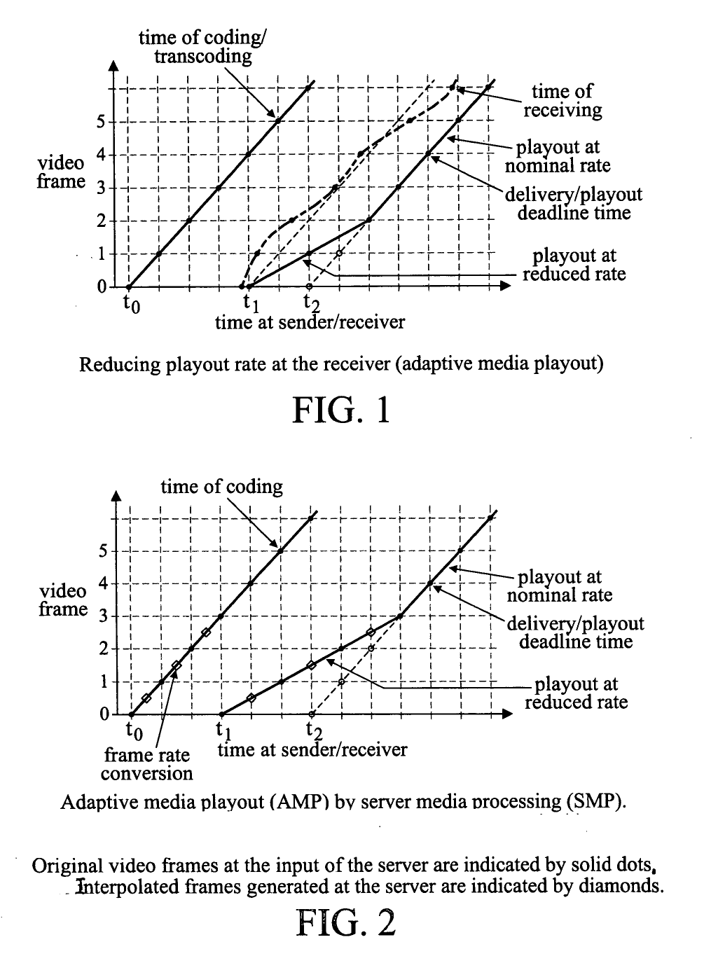

FIG. 1 illustrates how AMP can be used to achieve either a lower playout delay at startup compared to conventional playout, or more playout robustness at the same playout delay. Starting at time t₀, video frames are coded or transcoded periodically at the sender/server, as shown by the solid curve on the left. Packetized video data is received at the receiver/client after a random interval of time, as indicated by the dotted curve. Video data is buffered temporarily at the receiver, before being played out. Conventionally, playout of video frames occurs periodically, i.e., at a fixed rate, normally the frame rate. Example conventional playout schedules are illustrated in the figure by dotted curves, one starting at t₁ and the other starting at t₂. In the case of t₁, a shorter playout delay (startup latency) results; however, in this example, video data for several frames arrive late. In the case of t₂, a larger playout delay results; however, in this example, all data for all video frames arrives at the receiver on time. The solid curve shows the delivery/playout deadline when AMP is used. With AMP, the playout rate is reduced temporarily after startup. After this initial phase of reduced playout rate, playout at the normal rate is started. Compared to the conventional playout schedule starting at t₁, the playout schedule with AMP results in better playout robustness after the startup phase. Compared to the conventional playout schedule starting at t₂, the playout schedule with AMP results in a reduced playout delay at startup. Note that in FIG. 1, the startup phase only lasts for a short time, and the reduction in playout rate is relatively large, for illustration purposes. In an actual implementation, the change in playout rate with respect to the nominal playout rate may be much smaller, while the duration of the startup phase (during which playout rate is reduced) may be much larger.

While AMP can be used at startup, as illustrated in FIG. 1, it can also be used after the startup phase. AMP in general may include reducing the playout rate, and may also include increasing the playout rate. In existing system, AMP is realized by the receiver, by increasing the duration that each frame is displayed, or by increasing the number of frames/fields to be displayed. Control of the playout rate may be either at the sender or at the receiver.

FIG. 2 illustrates how Adaptive Media Playout by Server Media Processing (AMP-SMP) can be used to realize adaptive playout at startup. Note the magnitude of the effect is again exaggerated for illustration purposes. With AMP-SMP, frame rate conversion is implemented at the sender (server) side, instead of at the receiver (client) during the startup phase. Therefore, the number of video frames to be coded and transmitted per second is increased during this phase. The sender (server) may also modify the presentation time stamps (PTS) and decoding time stamps (DTS) of the existing and newly generated video frames, such that a desired playout schedule is followed at the receiver. Furthermore, since an increased number of video frames per second must be transmitted, the sender (server) may also modify the bit rate (i.e. the number of bits per coded frame) of the coded video stream. The video bit rate may be adapted to the conditions (e.g. bandwidth) of the channel (network). The receiver receives coded video frames and plays them at the normal display rate, i.e., the nominal frame rate of the video stream before frame rate conversion. The segment of the video that was subject to frame rate conversion contains an increased number of frames compared to the original video stream. Therefore, when the frames in this segment are played at the normal display rate, the duration of playout of this segment is increased to the duration of the same segment of the original video stream. As is clear from this example, the system may achieve adaptive playout at the receiver without additional processing at the receiver. In fact, the receiver may be oblivious to the fact that adaptive playout is achieved. All video processing needed to achieve adaptive playout may be realized at the server. Additional audio processing needed for time scaling of the audio component may also be realized at the server.

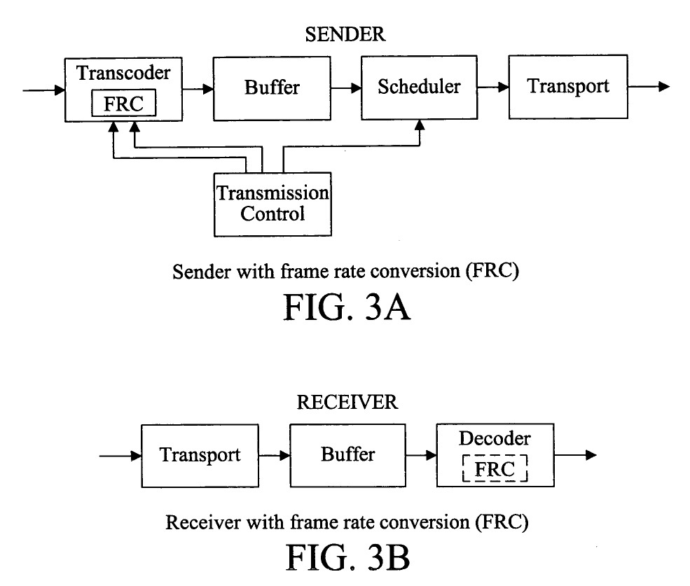

A block diagram of an audio/video transmission system with AMP-SMP is shown in FIG. 3. A source audio/video stream at the input of the sender may be either a pre-encoded stream available on a storage medium or a live input stream. The audio and video components of the source stream are subject to time scaling at the sender. Time scaling is realized by frame rate conversion (FRC) in the case of the video component. In addition, time scaling of the audio component is performed at the sender, in such a manner that corresponding portions of the audio and video contents remain substantially synchronized. In the case where the input is a digitally compressed video stream, frame rate conversion may be conveniently implemented by a video transcoder. The video transcoder may also control the output bit rate appropriately, for example by adapting to the time scaling factor and the expected channel conditions. In the case where the input is uncompressed video data, frame rate conversion and video encoding may be separate processes. In both cases (compressed or uncompressed), frame rate conversion and video encoding may be jointly optimized to achieve the best possible video quality. Coded audio/video data is subsequently scheduled for transport across the channel or network. The transport module at the sender illustrates further processing such as packetization, as well as for example a wireless transmitter. At the receiver, coded audio/video data is temporarily buffered, and subsequently decoded. As illustrated in the diagram, the receiver may also be capable of frame rate conversion (FRC), or it may not. Frame rate conversion capability at the receiver may be integrated with the decoder, or may be separate. The transport module at the receiver illustrates additional processing such as depacketization, as well as for example a wireless receiver.

The transmission control module in FIG. 3 controls: audio/video time scaling at the sender; when frame rate conversion is applied to the video; by what amount the frame rate is increased (or reduced); what target bit rate is used; and it controls the scheduler to transmit coded audio/video data at the appropriate rate.

Note that bit rate adaptation may be needed, depending on the channel capacity, because frame rate conversion at the server may generate additional video frames to be transmitted. However, because the additional video frames were generated from existing video frames, the server may be able to encode such frames very efficiently.

Note that the term frame rate conversion is used in a general manner. Frame rate conversion could be realized by frame or field repetition, frame or field interpolation, motion-adaptive interpolation, motion-compensated interpolation, and so on. Frame rate conversion may also include reduction of the frame rate, for example by dropping frames or fields. Frame rate reduction may be used to achieve a speedup of playout instead of a slowdown. This capability is advantageous in the case of live audio/video input.

Processing of the audio/video data at the server may be implemented in several manners, depending on the nature of the input signal and depending on the need for bit rate adaptation. The two main types of implementations may be termed pixel-domain frame rate conversion and compressed-domain frame rate conversion.

Pixel-Domain Frame Rate Conversion

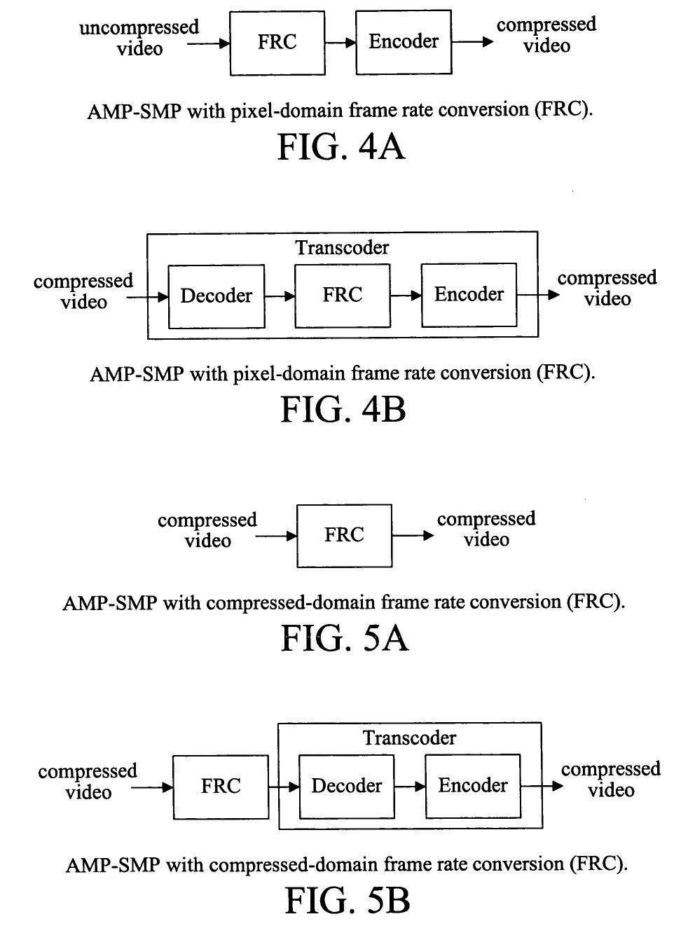

Frame rate conversion is normally carried out in the pixel domain, i.e., on uncompressed video frames. Two example AMP-SMP architectures with pixel-domain frame rate conversion are shown in FIG. 4. In FIG. 4A, the input to the server is uncompressed video, while in FIG. 4B, the input to the server is compressed video. In the latter case, the compressed data must first be decoded, before frame rate conversion in the pixel domain can be carried out. The decoder, conversion, and encoder combined form a video transcoder.

In a first case, the frame rate conversion may be performed independently of either decoding or encoding.

In a second case, the encoder is aware of which video frames it receives are original input frames and which frames are interpolated frames. In this case, the encoder may be able to encode such interpolated frames very efficiently, i.e., with relatively few bits. For example, all existing video coding standards such as MPEG-1, 2, 4, H.263, H.264, etc, provide the option to code a frame as an I-frame, P-frame, or B-frame. In this case, it may be advantageous to code interpolated frames as B-frames. Furthermore, various options exist within these coding standards, that enable effective prediction and therefore highly compressed encoding of such video frames.

In a third case (applicable to the architecture in FIG. 4B), the frame rate conversion and/or the encoder modules may be provided with data about the input video stream by the decoder. For example, motion vectors that are available in the coded input video stream may be re-used by the frame rate conversion process. This would enable the frame rate converter to apply motion-compensated frame rate conversion without the need for motion estimation, which is a computationally expensive process. Motion-compensated processing leads to a higher quality result. Another example would be information about the coding complexity of the input stream, which can be obtained by the decoder, and can be provided to the encoder. This would allow improved bit rate control.

Compressed-Domain Frame Rate Conversion

Two example AMP-SMP architectures with compressed-domain frame rate conversion are shown in FIG. 5. In FIG. 5A, frame rate conversion is applied without adapting the bit rate of the resulting bit stream. In FIG. 5B, frame rate conversion is followed by transcoding, which includes adapting the bit rate of the bit stream before transmission. The architecture of FIG. 5A may be applicable when the channel/network bandwidth is expected to always be higher than the bit rate required for transmission of the converted bit stream. Note that the number of frames to be transmitted per second is increased in the case of AMP-SMP compared to the case without AMP-SMP. The architecture of FIG. 5B is more appropriate when the conditions of the channel/network are expected to vary significantly or when the channel bandwidth is insufficient given the bit rate of the converted bit stream. The transcoder is able to adapt the bit rate of the compressed video to current and expected channel conditions.

Frame rate conversion is traditionally not carried out in the compressed domain. However, simple frame or field repetition could be performed in the compressed domain by direct manipulation of the video bit stream. In particular, repeating a frame encoded as a B-frame in a GOP may be advantageous, as it may require few extra bits.

AMP with Server-Side and Client-Side Media Processing Capability

In the case where the client has the capability to realize AMP, for example by frame rate conversion or other means, the server may adaptively decide to activate frame rate conversion or to let the client realize AMP by itself. That is, based on various constraints, the server may choose to:

a. realize AMP by frame rate conversion at the server without the need for additional processing by the client;

b. perform no processing at the server specific to achieving AMP, and let the client perform the necessary processing;

c. adaptively select an optimal number of frames to transmit and a number of frames to be interpolated at the client, for the purposes of AMP.

The server may select an optimal strategy depending on various factors, including the following.

a. Channel/network conditions. For example, when the channel bandwidth is high, the server may select to apply frame rate conversion by itself, in order to take advantage of the fact that it is able to process higher quality frames compared to the client. Note that the client should process frames that have been subject to compression, and note that in some cases audio/video data may be lost during transmission. On the other hand, when the channel bandwidth is low, the server may select to minimize the number of frames that need to be transmitted, and let the client perform the processing to achieve AMP.

b. Coding complexity of input audio/video stream. For example, when the coding complexity of the input stream is high, it may be expected that interpolated frames created by frame rate conversion at the server may be relatively expensive to encode and transmit in terms of the number of bits per frame. Therefore, in this case, it is advantageous to allow the client to perform frame rate conversion. On the other hand, when the coding complexity of the input stream is low, interpolated frames may be coded and transmitted efficiently by the server. In this case, it is advantageous for the server to perform frame rate conversion.

c. Server or encoder resources, in particular processing power and memory. Encoder resources may vary dynamically over time. When encoder resources run low, the server may let the client perform frame rate conversion. When encoder resources remain high, the server may perform frame rate conversion itself.

d. User preferences. Performing frame rate conversion on the server-side may result in a video sequence with smoother motion rendition but somewhat increased compression distortion per frame. This may be preferred by some users, while other users would prefer less distortion per frame at the cost of degraded motion rendition.

In order for the server to be aware of the AMP-related capabilities of the client, such capabilities would need to be signalled. Such signalling can be performed using any suitable protocol, before starting actual video streaming. Controlling the number of frames generated, encoded and transmitted per second

One method to control the number of video frames at the output of the frame rate conversion process is to adapt this number relative to the nominal (frame) rate of the original input video stream. This can be described with a scaling function, where the effective number of frames generated, encoded and transmitted per second is the product of the nominal frame rate and a scaling function.

During playout at the normal (nominal) frame rate, the scaling function has the value 1.0.

During a stream startup phase, the scaling function has a value greater than 1.0 to achieve a slowdown of the playout rate at the receiver. This means that video frames are encoded and transmitted at an increased number per second—faster than nominal frame rate.

In certain cases, it may also be useful to effect a reduction of the frame rate. This means that fewer video frames are encoded and transmitted per second than normal—at lower than nominal rate. In these cases, the scaling function is smaller than 1.0.

To achieve adaptive media playout, frame rate conversion may be applied for a fixed period of time. Alternatively, frame rate conversion may be applied for a variable period of time, for example until a desirable system status is received. For example, the sender may be informed by the receiver that the decoder buffer has reach a desired fullness.

The scaling function may be a piece-wise constant function. Alternatively, the scaling function may increase or decrease gradually over time. The scaling function may depend on the encoder buffer fullness. It may also depend on the decoder buffer fullness. The scaling function may depend on characteristics of the video data stream. The scaling function may depend on the delivery or playout deadline time of video frames. The scaling function may also depend on the end-to-end delay. The scaling function may be substantially controlled by the sender. The scaling function may be substantially controlled by the receiver. The scaling function may be jointly controlled by both the sender and the receiver.

Controlling the Bit Rate of the Video Stream

One method to control the bit rate of the audio/video stream at the output of the encoder or transcoder is to adapt it relative to the bit rate of the original input audio/video media stream. This method assumes that the available bandwidth of the channel or network is sufficient relative to the bit rate of the original stream, in the normal case where AMP-SMP is not applied.

This can be described with a second scaling function applied to the bit rate of the audio/video stream. The target bit rate at the encoder output is the product of the bit rate at the input and the bit rate scaling function.

During a stream startup phase, the bit rate scaling function is smaller than 1.0 when applying AMP-SMP. Therefore, the bit rate of the coded bit stream may be reduced during the startup phase. The bit rate scaling function may depend on the first scaling function. For example, the bit rate scaling function may be the inverse of the first scaling function. The bit rate scaling function may be constant during the period of time that AMP-SMP is applied. Alternatively, the bit rate scaling function may vary gradually during the period of time that AMP-SMP is applied. The bit rate scaling function may depend on characteristics of the video data stream.

In another method to control the bit rate of the audio/video stream at the output of the encoder, estimates of available bandwidth or throughput of the channel or network may be taken into consideration.

Another method to control the bit rate of the audio/video stream at the output of the encoder is to use the method of delay-constrained rate adaptation. Using delay-constrained rate adaptation, the bit rate of the video stream is adapted such that audio/video data substantially arrives on time, even in the case where the number of video frames encoded and transmitted per second has been increased. Delay-constrained rate adaptation may take into account the expected delays of audio/video data during transmission, or may take into account the expected available bandwidth for transmission of audio/video data. Therefore, limitations and variations of the channel bandwidth are inherently taken into account. Delay-constrained rate adaptation may also take into account the system status, such as fullness of the various buffers in the system, for example an encoder buffer, a decoder buffer, or a MAC buffer.

We claim:

1. A system for sending video comprising:
(a) a sender creating a second plurality of frames for a temporal time period of said video based upon a first plurality of frames for said temporal time period of said video, such that said second plurality of frames includes a greater number of frames than said first plurality of frames;
(b) said sender sending said second plurality of frames to a receiver at a frame rate greater than the frame rate at which said receiver is going to render said second plurality of frames.

2. The system of claim 1 wherein said sender adjust a bit rate of sending said second plurality of frames based on the bandwidth of a channel between said sender and said receiver.

3. The system of claim 1 wherein said sender modifies the desired presentation rate for presentation by said receiver of said second plurality of frames than the anticipated presentation rate of said first plurality of frames.

4. The system of claim 1 wherein said first plurality of frames is live video.

5. The system of claim 1 wherein said first plurality of frames is stored video.

6. The system of claim 2 wherein said bit rate is lowered with decreased bandwidth of said channel.

7. The system of claim 1 wherein said sending modifies a set of presentation time stamps for said second plurality of frames in such a manner that said second plurality of frames is rendered at a frame rate different than the frame rate of said first plurality of frames.

8. The system of claim 1 wherein said sender transcodes said video.

9. The system of claim 1 wherein said creating of said second plurality of frames is performed prior to encoding of said video for subsequent said sending.

10. The system of claim 1 wherein said sender incorporates a delay-constrained rate adaptation.

11. The system of claim 1 wherein said creating and subsequent encoding of said second plurality of frames are jointly optimized.

12. The system of claim 1 wherein said sender and said receiver jointly optimize said creating.

13. The system of claim 12 wherein said jointly optimizing includes selecting the number of frames to interpolate.

14. The system of claim 12 wherein said jointly optimizing includes selecting the number of frames to send.

15. The system of claim 1 wherein said first plurality of frames is the startup of said video.
